(19) United States
(12) Patent Application Publication
(10) Pub. No.: US 2015/0290972 A1
(43) Pub. Date: Oct. 15, 2015

(54) Wheel Lift and Transport Device

(71) Applicant: Vision Global Technology, Inc., Decatur, AL (US)

(72) Inventors: Danny R. Minor, Decatur, AL (US); Jonathan Henderson, Decatur, AL (US); Amnon Regev, Givatayim (IL)

(73) Assignee: Vision Global Technology, Inc., Decatur, AL (US)

(21) Appl. No.: 14/251,190

(22) Filed: Apr. 11, 2014

(51) Int. Cl. B60B 29/00; B66F 5/04

(52) U.S. Cl. CPC B60B 29/001; B66F 5/04; B60B 29/002

(57) ABSTRACT

A device for lifting, supporting and moving large vehicle wheels allows a single person to install and remove wheels. The device has a U-shaped frame with two opposed straight sides connected by a jack side of the frame. Lift arms rotatably affixed to the opposed straight sides have rotatable rollers that contact the vehicle wheel. The lift arms are connected to a jack via chains that translate vertical motion from the jack to raise the lift arms, and thus raise the vehicle wheel. The rollers allow a user to rotate the vehicle wheel to position it for reinstallation onto the vehicle. A stabilizer bar rotatably affixed to the frame contacts the vehicle lift to stabilize the wheel during use of the device.

### BACKGROUND AND SUMMARY

Changing the tires and wheels for large vehicles, such as RV's, industrial, commercial and military vehicles, has historically been a difficult task for a single person. The wheels on such vehicles are quite large, heavy and unwieldy to change. A device according to the present disclosure allows a single person to lift and transport and position heavy vehicle wheels of up to a thousand pounds.

A vehicle wheel lift and rotation device according the present disclosure has a U-shaped support frame with two opposed straight sides configured to receive opposite sides of a vehicle wheel. Opposed lift arms are rotatably affixed to the opposed straight sides, each lift arm comprising a roller configured to contact a vehicle wheel. A jack is centrally affixed to a front side of the support frame, the jack connected to the lift arms via one or more chains. When a user actuates the jack, the chains draw the lift arms towards one another such that the rollers rotatably contact and lift the vehicle wheel.

While the vehicle wheel is lifted by the device, it is rotatable within the rollers to allow positioning of the wheel relative to the lug nuts on the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is a front perspective view of the device according to an exemplary embodiment of the present disclosure.

FIG. 2 is a top perspective view of the device of FIG. 1.

FIG. 3 is a front perspective view of the device of FIG. 1, in operation to remove a wheel.

FIG. 4 is a top perspective view of the device of FIG. 1, with the lift arms fully retracted.

FIG. 5 is a front perspective view of the device of FIG. 1 with the pull handle extended.

FIG. 6 is a front perspective view of the device of FIG. 1 with the pull handle retracted.

FIG. 7 is a rear perspective view of the device of FIG. 1.

### DETAILED DESCRIPTION

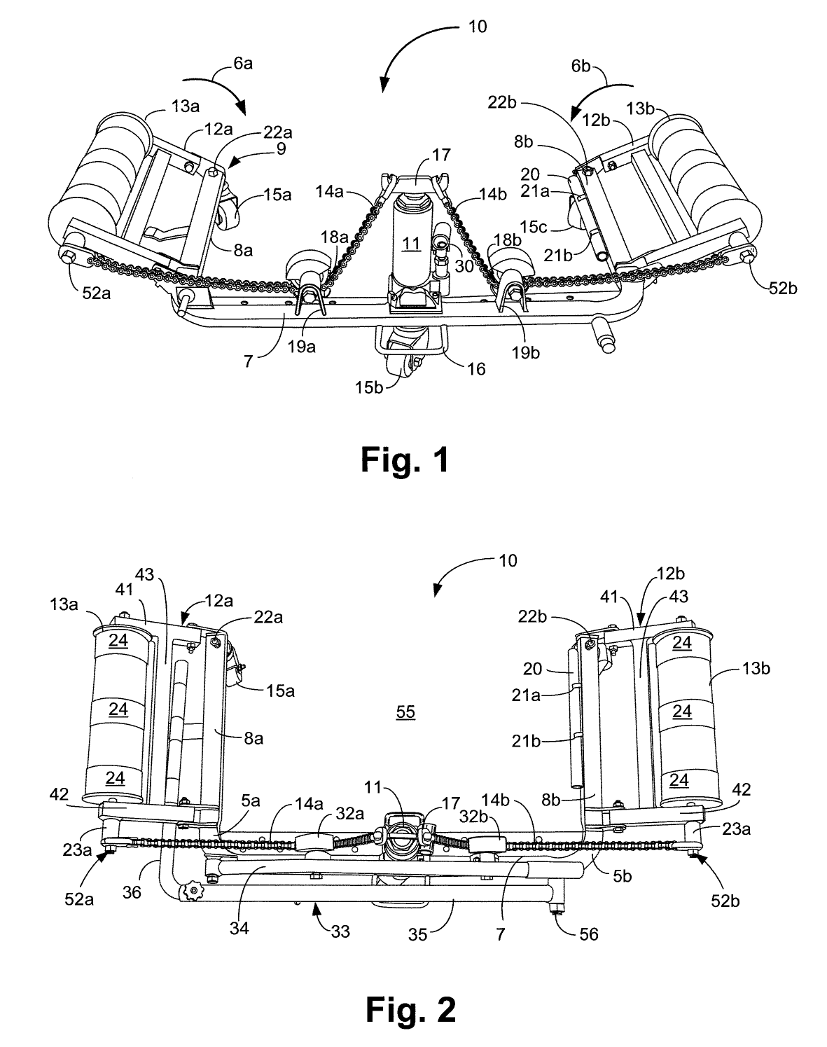

FIG. 1 is a front perspective view of the device 10 according to an exemplary embodiment of the present disclosure. The device 10 comprises a support frame 9 that rotatably supports two lift arms 12a and 12b. The support frame 9 is generally U-shaped when viewed from above, with a jack side 7 flanked by opposed straight sides 8a and 8b. The lift arms 12a and 12b rotatably extend from the straight sides 8a and 8b, respectively.

The lift arm 12a comprises a roller 13a, and the lift arm 12b comprises a roller 13b. The rollers 13a and 13b rotate freely on their respective lift arms 12a and 12b, and together contact and cradle a vehicle wheel (not shown) for lifting and rotating the vehicle wheel.

A jack 11 is centrally disposed on the jack side 7 of the frame 9. The jack 11 provides the lifting mechanism for the lift arms 12a and 12b, and in the illustrated embodiment a basic hydraulic bottle jack. The lift arms 12a and 12b rotate toward one another in the direction indicated by directional arrows 6a and 6b when the jack 11 is operated by a handle 20. Note that the handle 20 is shown in FIG. 1 attached to the frame 9. The handle 20 is releasably attached to the frame 9 for stowage, and is removed from the frame 9 and used to actuate the jack 11 when the jack 11 is in use.

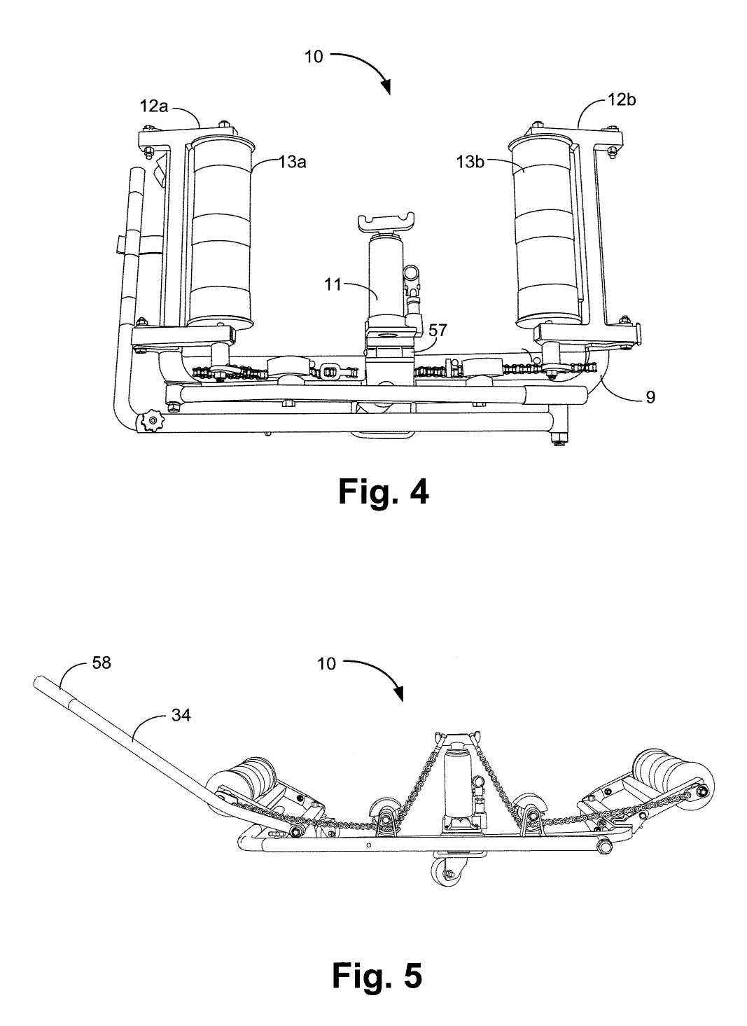

The lift arms 12a and 12b also rotate inwardly to create a smaller footprint of the device 10 for storage, as illustrated in FIG. 4 herein.

Chains 14a and 14b connected between the lift arms 12a and 12b and the jack 11 draws the arms 12a and 12b towards one another when the jack 11 is operated. In this regard, a chain 14a is affixed at its innermost end to a bracket 17 on the jack 11, through a sprocket 18a and then to the lift arm 12a at the outermost end of the chain 14a. Similarly, chain 14b is affixed at its innermost end to the bracket 17, through a sprocket 18b and then to the lift arm 12b at the outermost end of the chain 14b. When the jack is operated, the bracket 17 moves upward, exerting an upward force on the chains 14a and 14b, which draw the lift arms 12a and 12b toward one another. The sprockets 18a and 18b translate the vertical motion of the jack 11 to lateral motion to draw the arms 12a and 12 be toward one another.

In the illustrated embodiments, the chains 14a and 14b are roller type chains similar to those used for bicycles, The chains 14a and 14b engage with the sprockets 18a and 1 8b in a manner similar to bicycle chains and sprockets. The sprockets 18a and 18b are supported by sprocket brackets 19a and 19b, respectively. The sprocket brackets 19a and 19b extend from and are rigidly affixed to the jack side 7 of the frame 9, on either side of the jack 11.

A plurality of wheels 15a-15c allows the device 10 to transport a vehicle wheel by a user manually pushing the lift. In the illustrated embodiment, there are three (3) wheels 15a-15c, though other embodiments could have a different number of wheels. The wheel 15a is disposed near a free end of the side 8a, the wheel 15e is disposed near a free end of the side 8b, and the wheel 15b is disposed centrally on the jack side 7, generally beneath the jack 11. The wheel 15a attaches to the straight side 8a via a fastener 22a, and the wheel 15c attaches to the straight side 8b via a fastener 22b. The wheel 15b attaches to the jack side 7 via a fastener (not shown). In the illustrated embodiment, the wheels 15a-15e comprise swivel rollers.

The frame 9, lift arms 12a and 12b, jack 11 and other components of the device 10 are formed from steel in one embodiment, but other suitably strong and rigid materials may be used to form these components without departing from the scope of the present disclosure.

The device 10 is used to remove and reinstall a vehicle wheel while the vehicle wheel is on the vehicle, with the vehicle wheel already jacked up via a separate jack (not shown) such that the vehicle wheel is not supporting the weight of the vehicle. In operation of the device 10 to remove and reinstall a vehicle wheel the user (not shown) slides the device 10 under the vehicle wheel such that the sides 8a and 8b of the frame 9 are on opposite sides of the vehicle wheel, and the jack side 7 of the frame 9 is adjacent to the front of the vehicle wheel. The lift arms 12a and 12b should be in their fully deployed position (i.e., rotated open), during this step of the vehicle wheel removal process. Because the central area of the device 10 is open, the device 10 will surround the vehicle wheel on three sides.

The user then actuates the jack 11 in the traditional manner, using a detachable handle 20 installed in a crank 30 to crank the jack 11, causing the bracket 17 on top of the jack 11 to move vertically and the chains 14a and 14b to draw the lift arms 12a and 12b toward one another. The rollers 13a and 13b eventually contact the vehicle wheel and lift it from the ground so that it can be moved. The user can then remove the vehicle wheel from the vehicle by rolling the device 10 away from the vehicle. When the handle 20 is not in use, the handle 20 is releasably affixed to the side 8b via friction clips 21a and 21b. The handle 20 is a short length of hollow tubing in the illustrated embodiment.

To reinstall the vehicle wheel on the vehicle, the process is repeated in reverse. Because the rollers 13a and 13b rotate freely with respect to the lift arms 12a and 12b, the vehicle wheel is rotatable while it is being lifted, allowing the user to easily align the vehicle wheel lug openings with the lugs. After the vehicle wheel is reinstalled, the user releases the jack 11 to open the lift arms 12a and 12b and lower the vehicle Wheel. Then the device 10 can be rolled away from the vehicle.

A handle 16 extends from the frame 7 and allows the user to pick up the device 10 by hand for transport. in the illustrated embodiment, the handle comprises a U-shaped extension extending from a front edge of the jack side 7 of the frame 9.

FIG. 2 is a top view of the device 10 of FIG. 1. The straight sides 8a and 8b are generally parallel with one another and are generally perpendicular to the jack side 7 of the frame 9 such that the frame 9 has a U-shape when viewed from above as shown. A central area 55 of the device 10 is open for receiving a vehicle wheel (not shown).

The straight sides 8a and 8b and the jack side 7 are formed unitarily as one piece, generally from a bent section of steel. In the illustrated embodiment, the straight sides 8a and 8b and the jack side 7 are formed from a length of approximately 0.75×1.50 hollow steel tubing. Other sizes and shapes of tubing are used to form the straight sides 8a and 8b and the jack side 7 in other embodiments. A rounded corner 5a is formed at the intersection of the straight side 8a and the jack side 7 of the frame 9, and a rounded corner 5b is formed at the intersection of the straight side 8b and the jack side 7 of the frame 9.

The detachable jack handle 20 is releasably stowed adjacent to the straight side 8b. In this regard, friction clips 21a and 21b extend from the straight side 8b and receive the jack handle 20. The jack handle 20 is used by the user to actuate the jack 11.

The wheel 15a attaches to the straight side 8a via the fastener 22a, and the wheel 15c (FIG. 1) attaches to the straight side 8b via the fastener 22b. The wheel 15b (FIG. 1) attaches to the jack side 7 via a fastener (not shown).

The chains 14a and 14b lie in a generally straight line between the outward ends 52a and 52b of the lift arms 12a and 12b, and the jack 11, when viewed from the top. The lift arm 12a comprises an extension 23a to which the outer end of the chain 14a attaches. The lift arm 12b comprises an extension 23b to which the outer end of the chain 14h attaches.

Sprocket covers 32a and 32b extend over the tops of the sprockets 18a and 1 8b (FIG. 1) and protect the user from getting caught between a sprocket and a chain. The sprockets 18a and 18b lie in the same plane as the chains 14 and the bracket 17 on jack 11.

The rollers 13a and 13b comprise non-slip portions 24. The non-slip portions 24 allow the tire (not shown) to gain traction with the rollers 13a and 13b. In the illustrated embodiment, the non-slip portions 24 are in the form of non-skid tape applied to the rollers 13a and 13b. In other embodiments, other means of providing traction between the tires and the rollers 13a and 13b is provided, such as roughing up the surface of the rollers 13a and 13b, applying non-skid paint, or the like.

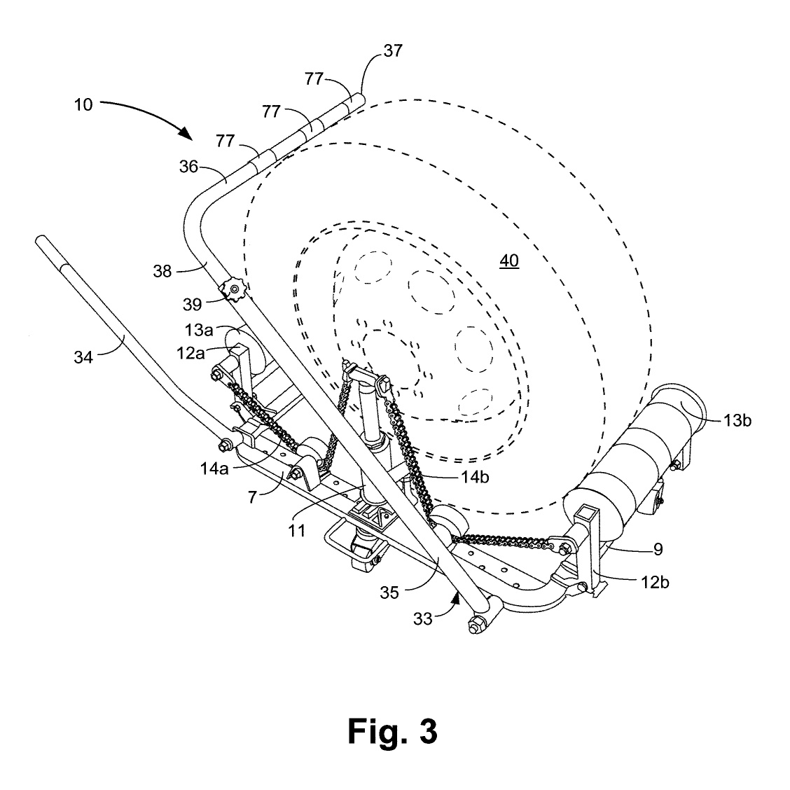

A stabilizer bar 33 is rotatably affixed to the jack side 7 of the frame 9. The stabilizer bar 33 comprises an outer sheath 35 that is generally parallel to and extends alongside the jack side 7 of the frame 9 when the stabilizer bar 33 is in a “stowed” orientation, i.e., the stabilizer bar 33 is not in use. The outer sheath 35 of the stabilizer bar 33 is rotatably affixed to a front edge of the jack side 7 near the rounded corner 5b, and is affixed to the frame 9 via a fastener 56. The outer sheath 35 is rotatable from a generally horizontal position to a generally vertical position. The stabilizer bar 33 is discussed in more detail with respect to FIG. 3 herein.

A pull handle 34 is rotatably affixed to the frame 7 near the rounded corner 5a. The pull handle 34 is illustrated in a stowed orientation in FIG. 2, and in this stowed orientation the pull handle 34 is general parallel to and is stowed alongside the jack side 7 of the frame 9. The pull handle is shown FIG. 3 in its deployed position. The pull handle is generally rotatable a full 180 degrees during its deployment.

The support arms 12a and 12b are shown as rotated hilly open in FIG. 2. The support arms 12a and 12b are generally identical mirror images of one another, and the rollers 13a and 13b are generally identical to one other. The support arms 12a and 12b each comprise a substantially “H” shaped frame, with opposed short ends 41 and 42 joined together by a central support 43. The rollers 13a and 13b are each rotatably affixed between their respective short ends 41 and 42, and the rollers 13a and 13b are substantially perpendicular to the short ends 41 and 42 and substantially parallel to the central support 43. The support arms 12a and 12b are rotatably affixed to the ends 8a and 8b, respectfully, at the short ends 41 and 42 opposite from the rollers 13a and 13b. In other words, the rollers 13a and 13b are affixed to the short ends 41 and 42 at the outermost ends of the short ends 41 and 42 (when the support arms 12a and 12b are rotated open), and the innermost ends of the short ends 41 and 42 are rotatably affixed to the ends 8a and 8b of the frame 9.

FIG. 3 is a front perspective view of the device 10 of FIG. 2 supporting a vehicle wheel 40. In this configuration, the support arms 12a and 12b are deployed and the rollers 13a and 13b are contacting and support the vehicle wheel 40. The stabilizer bar 33 is also in a “deployed” orientation to support the vehicle wheel 40. In this regard, the stabilizer bar 33 has been rotated from its stowed position such that it contacts an upper surface of the vehicle wheel 40.

A tire support portion 36 of the stabilizer bar 33 is slideably received by the outer sheath 35 and comprises a generally L-shaped tube, wherein a free end 37 of the tire support portion 36 is substantially perpendicular to a lower portion 38 of the tire support portion 36. The lower portion 38 is slideably and adjustably received the outer sheath 35. A knob 39 may be loosened by hand to adjust the length of the stabilizer bar 33, and tightened when the stabilizer bar 33 is the desired length.

The tire support portion 36 is contactable with the vehicle wheel 40 to support the vehicle wheel 40 such that it cannot tip and fall from the rollers 13a and 13b. The tire support portion 36 comprises non-slip portions 77. The non-slip portions 77 allow the tire (not shown) to have traction with the tire support portion 36.

In one embodiment, the device 10 is sized and configured to support large vehicle wheels between 33 inches and 44 inches in diameter, though other sized vehicle wheels can be accommodated without departing from the scope of the present disclosure.

FIG. 4 is a top view of the device 10 with the lift arms 12a and 12b folded inward, giving the device 10 a smaller footprint and thus making the device 10 more stowable. The jack 11 also folds downward as shown, creating a smaller footprint for transporting the device 10. In this regard, the jack 11. is hingedly affixed to the jack side 7 (FIG. 1) of the frame 9 via one or more hinges 57, such that the jack is rotatable from a generally vertical orientation (as shown in FIGS. 1-3) to a generally horizontal orientation (as shown in FIG. 4).

FIG. 5 is a front perspective view of the device 10 of FIG. 1, with the pull handle 34 deployed such that the user (not shown) can pull the device by grasping a grip portion 58 of the pull handle 34. By pulling the device via the pull handle 34, a single user can transport a vehicle wheel (not shown) in the device 10 without any assistance.

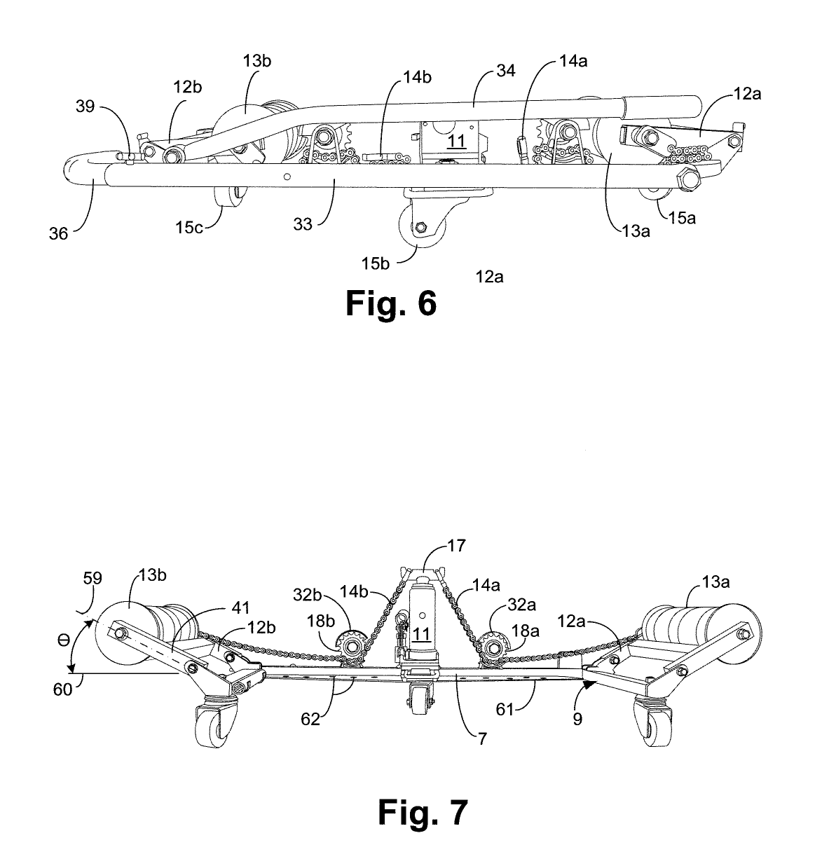

FIG. 6 is a front perspective view of the device 10 of FIG. 1 with the rollers 13a and 13b stowed (rotated inwardly) and the pull handle 34 and the stabilizer bar 33 stowed. The jack 11 is also rotated inwardly in this view. Note that when the rollers 13a and 13b are rotated completely inwardly, the lift arms 12a and 12b are generally horizontal to the ground. When the rollers 13a and 13b are rotated inwardly in this manner, the chains 14a and 14b can be disconnected from the bracket 17 (FIG. 1) of the jack 11 as shown. A plate 61 (FIG. 7) prevents the chains 14a and 14h from dragging along the ground when they are disconnected from the jack 11.

FIG. 7 is a rear perspective view of the device of FIG. 1. Note that in FIG. 1 and FIG. 7, the pull handle 34 and the stabilizer bar 33 are not shown for the sake of clarity in viewing the remaining components. The plate 61 is affixed to the jack side 7 of the frame and extends beneath the chains 14a and 14b. The plate 61 comprises a thin sheet of metal in the illustrated embodiment, with a plurality of openings 62 extending through the plate 61 to allow water to drain through the plate 61.

The support arms 12a and 12b are shown as fully extended in FIG. 7, and in this deployed orientation an angle 0 between a horizontal plane (represented by reference line 60) and a plane of the support arm 12b (represented by centerline 59) is generally 30 degrees. When the support arms 12a and 12b are fully retracted (as shown in FIG. 6), the angle θ is generally 180 degrees. Therefore, the support arms 12a and 12b are generally rotatable from 30 degrees from the horizontal through 150 degrees of rotation.

1. A vehicle Wheel lift device comprising
a U-shaped frame with two opposed straight sides affixed to a jack side, the opposed straight sides spaced apart to receive opposite sides of a vehicle wheel;
lift arms rotatably affixed to the opposed straight sides, the lift arms each comprising a roller;
a jack centrally affixed to the jack side of the frame, the jack connected to the lift arms via one or more chains, wherein when the jack is actuated, a bracket on the jack moves substantially vertically and the chains draw the lift arms towards one another such that the rollers rotatably contact and lift the vehicle wheel.

2. The device of claim 1, wherein the jack is rotatable substantially 90 degrees inwardly with respect to the frame, when the jack is not in use.

3. The device of claim 1, wherein the lift arms are rotatable inwardly from a deployed position wherein the lift arms are disposed substantially 30 degrees from a horizontal plane through 150 degrees of rotation to a stowed position.

4. The device of claim 1, further comprising three wheels swivelly affixed to the frame configured to support and transport the device, the three wheels comprising one wheel centrally affixed beneath the jack side of the frame and one wheel affixed beneath each free end of an opposed straight side of the frame.

5. The device of claim further comprising a stabilizer bar rotatably affixed to the frame, the stabilizer bar rotatable to contact and support an upper surface of the vehicle wheel.

6. The device of claim 5, the stabilizer bar comprising an outer sheath rotatably affixed to the frame and an L-shaped tire support portion that is slideably and adjustably received by the outer sheath, a free end of the L-shaped tire support portion disposed substantially perpendicular to the outer sheath and substantially parallel to the rollers, the free end of the tube configured to contact the upper surface of the vehicle wheel.

7. The device of claim 5, Wherein a length of the stabilizer bar is adjustable by actuating a knob affixed to the stabilizer bar, wherein loosening the knob allows the L-shaped tire support portion to slide within the outer sheath and wherein tightening the knob affixes the L-shaped tire support portion within the outer sheath.

8. The device of claim 1, further comprising a pull handle rotatably affixed to a front edge of the jack side of the frame near an intersection of the jack side with one of the opposed straight sides, the pull handle rotatable from a stowed position substantially aligned with the jack side of the frame to an extended position.

9. The device of claim 1, further comprising a lift handle, the lift handle comprising a substantially U-shaped extension extending from a front edge of the jack side of the frame.

10. The device of claim 1, further comprising two sprockets rotatably affixed to the jack side of the frame, each sprocket disposed between the jack and one of the opposed straight sides, the sprockets engaged with the chains to translate vertical motion of the jack to lateral motion that draws the lift arms towards one another.

11. A vehicle wheel lift device comprising
a U-shaped frame with two opposed straight sides affixed to a jack side, the opposed straight sides configured to receive opposite sides of a vehicle wheel;
lift arms rotatably affixed to the opposed straight sides, the lift arms each comprising a roller;
a jack centrally affixed to the jack side of the frame, the jack connected to the lift arms via two chains, each chain engaging with a sprocket disposed between the jack and the lift arm, wherein when the jack is actuated, a bracket on the jack moves substantially vertically, the sprockets translate the vertical movement of the jack into lateral movement, and the chains cause the lift arms to rotate towards one another until the rollers rotatably contact and lift the vehicle wheel.

12. The device of claim 11, the stabilizer bar comprising an outer sheath rotatably affixed to the frame and an L-shaped tire support portion that is slideably and adjustably received by the outer sheath, a free end of the L-shaped tire support portion disposed substantially perpendicular to the outer sheath and substantially parallel to the rollers, the free end of the tube configured to contact the upper surface of the vehicle Wheel.

13. The device of claim 12, wherein a length of the stabilizer bar is adjustable by actuating a knob affixed to the stabilizer bar, wherein loosening the knob allows the L-shaped tire support portion to slide within the outer sheath and wherein tightening the knob affixes the L-shaped tire support portion within the outer sheath.

14. The device of claim 11, wherein the jack is rotatable substantially 90 degrees inwardly with respect to the frame, when the jack is not in use.

15. The device of claim 11, wherein the lift arms are rotatable inwardly from a deployed position wherein the lift arms are disposed substantially 30 degrees from a horizontal plane through 150 degrees of rotation to a stowed position.

16. The device of claim. 11, further comprising three Wheels swivelly affixed to the frame configured to support and transport the device, the three wheels comprising one wheel centrally affixed beneath the jack side of the frame and one Wheel affixed beneath each free end of an opposed straight side of the frame.

17. The device of claim 11, further comprising a pull handle rotatably affixed to a front edge of the jack side of the frame near an intersection of the jack side with one of the opposed straight sides, the pull handle rotatable from a. stowed position substantially aligned with the jack side of the frame to an extended position.

18. The device of claim 11, further comprising a lift handle, the lift handle comprising a substantially U-shaped extension extending from a front edge of the jack side of the frame.
